(19) United States
(12) Patent Application Publication
(10) Pub. No.: US 2022/0256825 A1
(43) Pub. Date: Aug. 18, 2022

(54) Fishing Lure with Moving Appendages

(71) Applicant: Robert E. Marsh, Kansas City, MO (US)

(72) Inventor: Robert E. Marsh, Kansas City, MO (US)

(21) Appl. No.: 17/673,469

(22) Filed: Feb. 16, 2022

Related U.S. Application Data
(60) Provisional application No. 63/150,394, filed on Feb. 17, 2021.

(51) Int. Cl. A01K 85/00

(52) U.S. Cl. CPC A01K 85/1813

(57) ABSTRACT

A fishing lure having a body and at least one appendage. The fishing lure receives a hook attached to a fishing line. The bend of the hook engages a tendon or actuator such that force applied to the hook results in direct movement of the appendage(s) with resulting lifelike fishing lure action.

### BACKGROUND OF THE INVENTION

This invention relates to artificial fishing lures used to attract and catch fish. Fishing lures have at least one hook, usually made of wire, with an eye, at least one shank with a bend, and a barbed point at the end. Generally the hook is a wire with an essentially uniform diameter (except near the pointed end of the hook). A fishing lure is attached to a fishing line, the lure is cast into the water, and retrieved via the fishing line. The line is often attached to the eye of the hook, but sometimes is attached to another attachment point on the lure. This invention relates to lures where the line is attached to the hook.

Lifelike appearance, and ideally motion, of fishing lures is important. One method of creating lifelike movement is to have various portions of the lure move to simulate moving appendages. The appendage may be a single appendage, like the tail of a tadpole or minnow, or multiple appendages such as the legs of a frog, the pincers of a crawfish, or the wings of an insect. A wide variety of other appendages of various simulated fish prey maybe utilized. In the case of prior art fishing lures, the appendages are usually designed to move as a result of the lure moving through the water. To a careful observer, however, this motion is not realistic. The movement of the appendages should drive the motion of the simulated prey, not be the result of that motion. For that reason, appendage motion resulting from the dragging of the lure appears to be unnatural.

Prior art fishing lures are designed for a hook that is stationary relative to the body of the lure, in other words the hook is attached to the fishing line and is placed in the lure in a fixed position. It is traditionally not desirable for the hook to move relative to the lure, and prior art lures are designed to prevent hook movement.

For purposes of this invention, a fishing lure comprises the body and at least one appendage. The body and the appendage may be rigid or soft. For example, the body or appendage may be constructed of hard plastic or wood where rigidity is desired or constructed of silicone or another soft plastic or rubber (either hollow or continuous) where a soft, flexible body and/or appendage is preferred.

In this description references to the front or rear of the lure, or references to the longitudinal axis, refer to the lure in the position it would be in when in use fishing, such as floating on the surface of the water with the line attached to a hook eye at the front of the lure and typically with the appendages at the rear of the lure. Front and rear should be considered relative to the position of the lure when the lure is being retrieved while fishing. For example, if the lure is retrieved tail first (such as a crawdad-simulating lure) the front of the lure would be the “tail” of the backwards swimming crawdad and the front pinchers (the appendages) would be at the rear of the lure. A longitudinal axis runs the length of the lure, and a reference to “approximately” at the longitudinal axis would mean within a cylinder having its center axis at the longitudinal axis of the lure and having a diameter up to 50% of the diameter of the lure at its widest location.

As used in this description, “mechanical” or “direct” movement of an appendage refers to appendage movement that is not just the result of water moving past the lure as it is pulled through the water. The appendage movement in this invention is direct or mechanical in the sense that it results directly from movement of the hook as described in more detail below.

While in one embodiment this lure has a single appendage, for convenience most of the discussion below refers to multiple appendages. The entire description should be read with “appendages” meaning “one or more appendages.”

### BRIEF SUMMARY OF THE INVENTION

An object of this invention is to provide a fishing lure with appendage motion that is caused directly by force applied to the hook of the fishing lure and not simply as a result of the motion of the fishing lure. This direct appendage motion is created through the engagement of the hook with structure of the lure that is associated with the appendages so that force applied to the line tied to the hook results in movement of the appendages. This structure associated with the lure may be an actuator or a tendon, as described in more detail below. In the present invention, the hook is located in the body of the lure so that the hook shank moves longitudinally relative to the body. The fishing line is attached directly to the eye of the hook and the hook slides along the longitudinal axis of the body of the fishing lure in response to force applied to the eye of the hook. At least one appendage of the lure is moved directly by movement of a hook relative to the lure body. In a preferred embodiment the hook engages a tendon with at least one end anchored in a portion of the appendage. In another embodiment the hook engages an actuator that is integral with the fishing lure body and appendages. In both embodiments force on the line to the hook results in life like motion of at least one appendage.

### BRIEF DESCRIPTION OF THE SEVERAL VIEWS OF THE DRAWINGS

FIG. 1 shows a side view of the fishing lure of the present invention.

FIG. 2 shows a top view of the fishing lure of the present invention.

FIG. 3 shows an end view of the fishing lure of the present invention.

FIG. 4 shows top view of an embodiment of the present invention.

FIG. 5 shows a top view of another embodiment of the present invention.

### DETAILED DESCRIPTION OF THE INVENTION

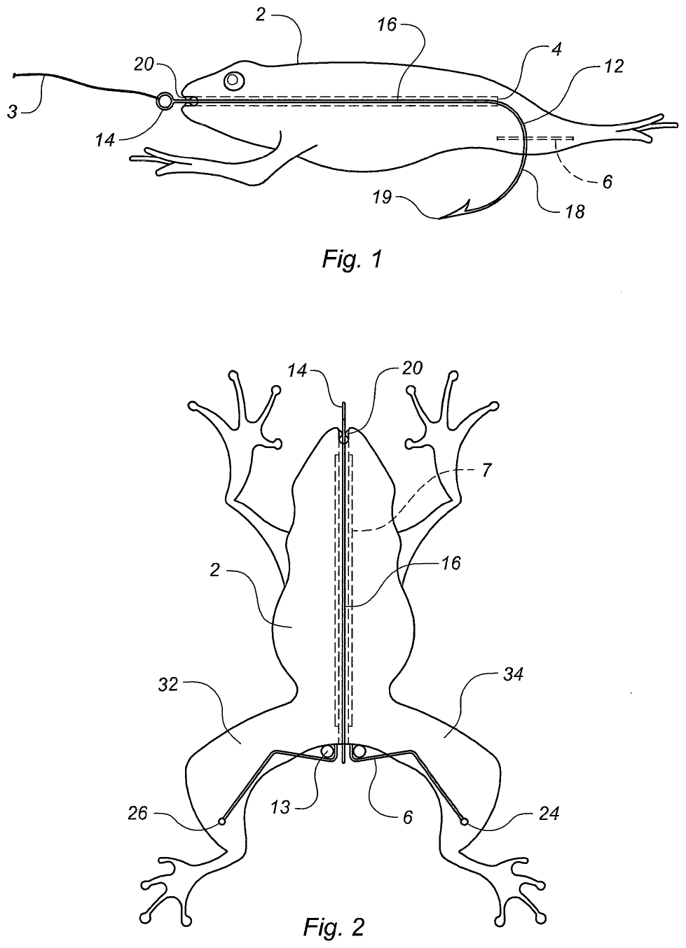

FIG. 1 shows a fishing lure intended to replicate a frog having a body 2 and receiving hook 12 within body 2. Hook 12 has an eye 14, a shank 16, a bend 18 and a barbed point 19. In the position shown in FIG. 1, hook shank 16 is located at approximately the longitudinal axis of the body 2 of the lure. The hook shank may be placed in this location either by being pressing it through the body 2 of a soft lure or it may fit within a channel preformed in the body of a lure at approximately the longitudinal axis. In one preferred embodiment, a tube (separate from the channel) may be located in the body of the lure at approximately the longitudinal axis specifically configured for receiving the hook shank. Channel 4 (or a separate tube located in the position of the channel shown) is preferably cylindrical with an inner diameter sized as described below. The fishing lure shown in FIG. 2 has appendages 32 and 34. The appendages may be a solid material, or preferably a soft, flexible material. They may be one piece or may be jointed. If one piece, they are preferably designed to have lifelike movement as if they were jointed, as would be known to one skilled in the art.

In the fishing lure shown in FIG. 1 the shank of the hook moves in a longitudinal direction as a result of tension on line 3 attached to the eye 14 of the hook. As the hook moves forward, the bend 18 of the hook engages tendon 6. In the embodiment shown in FIG. 1, tendon 6 is approximately perpendicular to the longitudinal axis of the lure and is located near the rear of the lure such that the tendon approximately intersects the longitudinal axis of the lure. Ends of the tendon are attached to appendages 32 and 34 as shown in FIG. 1 In a preferred environment the tendon may be slightly below the longitudinal axis of the lure. As the hook moves forward, the bend of the hook engages the tendon and pulls the tendon forward with a resulting force applied to the appendages. FIG. 2 shows tendon attachment points 24, 26 at each appendage.

FIG. 2 shows one embodiment of the present invention without the hook in position. Lure body 2 is formed with a longitudinal cylindrical channel running the length of the lure at approximately its longitudinal axis. Optionally, tube 7 is inserted within channel 4. When the hook 12 is added to the fishing lure shown in FIG. 1 it would be inserted with the eye at the front of the lure and the hook shank in the channel 4 (or within tube 7 if applicable). Optionally, constricting neck 20 may be located at the front end of channel 4 or tube 7 positioned so that the eye 14 of the hook would be forward of the constricting neck 20. The constricting neck is resilient and some force is required to press the eye of the hook through the constricting neck. The constricting neck serves to prevent the eye 14 of the hook from slipping too far back into the channel or tube. The constricting neck also serves to prevent debris from entering the channel or tube.

The tendon and appendages are preferably biased so that they tend to return to their original position after the force exerted on the tendon (by the bend of the hook) is removed. The tendon could be substantially rigid, like a wire or non-stretching polymer filament, or elastic, like a rubber or silicone line. Biasing could be provided by flexible structure of the lure or its appendages or by springs or other suitable biasing components well known in the art. The tendon is connected to at least one appendage, or in the example shown in FIG. 2, two appendages. Appendages could be legs, pincers of a crawfish, wings, a tail, or other simulated bait appendages. The tendon may be attached to the appendages externally (with little or none on the tendon passing through the appendage) or preferably a substantial portion of the tendon is contained within the appendages of the lure, as shown in FIG. 4. In one preferred embodiment the tendon would be monofilament line (like fishing line). In that embodiment, small fishing hooks could be placed in the appendages with the tendon ends tied to the eyes of those fish hooks, thereby anchoring the tendon ends in the appendages. In this embodiment it may be desirable to affix the tendon to the primary fish hook (that engages the tendon), such as with a knot, so that if a fish is hooked on one of these small hooks that hook will be attached to the primary hook.

Another biasing configuration is a spring (metal, plastic or other suitable material) disposed between the hook eye and the sleeve, or between the hook bend and the sleeve, such that pulling the line attached to the hook, thus pulling the hook through the sleeve loads the spring (either by stretching or compressing) so that when the line tension is released the hook tends to return to its original position relative to the sleeve. Such a hook, spring, sleeve combination could be inserted in the body of a soft fishing lure, especially a fishing lure with a pre-formed longitudinal channel sized to receive the hook, sleeve, spring structure.

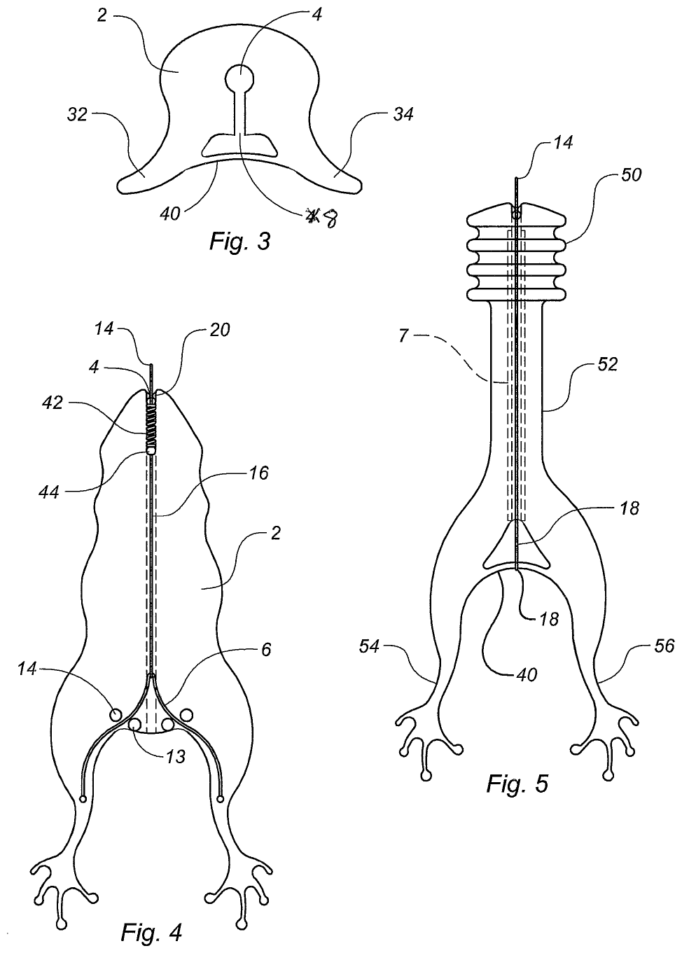

As shown in FIG. 3, in one embodiment an opening 8 in the lure, at the back of the lure and at the bottom of the lure, permits the bend of the hook to slide forward. Preferably the opening is rectangular, with its length (long edge) parallel to the longitudinal axis of the lure. The width of the opening may be more or less than the diameter of the hook, or preferably approximately equal to the diameter of the hook. Ideally the opening would extend no further than ⅔ of the lure length and preferably between ⅛ and ½ of the lure length, and even more preferably ⅛ to ¼ of the lure length. If necessary, the opening should also extend through a portion of tube 7 shown in FIG. 3 so that the hook bend can move forward past the rear end of the tube.

As described, the hook shank slides longitudinally within the channel or tube. The channel or tube diameter may be more or less than the hook shaft diameter (or approximately the same as the hook shank diameter) depending on the ease of movement of the hook desired. For example, if it is desirable for the hook to slide very easily in the channel or tube, the channel of tube should have a diameter larger than the hook shaft diameter. The ease of hook movement should be selected based on such factors as the resistance of the lure body in the water, the amount of desired appendage movement, and other similar factors. The material used for the body of the lure and/or the tube is also a factor. A soft lure body or soft sided channel may lead to more hook resistance. Alternatively, a harder surface lure body and channel (or, more preferably, a harder material tube) leads to less hook shank resistance. In a preferred embodiment a tube is made of plastic harder (and smoother) than the material of the soft lure body. In another embodiment, there is no pre-defined channel and no tube. Instead, the hook is forced into the center of a soft lure body (approximately along its longitudinal axis) thereby creating its own effective “channel” approximately along the longitudinal axis. If desired, a lubricating substance (such as glycerin) or a low friction tube inner surface (well known in the art) may be sued to decrease hook movement resistance.

The method and location of attaching the tendon to the appendage or appendages can be varied based on the movement desired. In the configuration shown in FIG. 2, the tendon attaches to a portion of the leg of a simulated frog lure. A flexible tendon is desirable and allows movement around other lure elements, such as the tendon guide 13 in FIG. 2. Such a tendon guide is desirable to define the motion of the tendon. The embodiment shown in FIG. 4 has multiple tendon guides 13,14 to even more narrowly define the path of movement of the tendon. Tendon guides 13, 14 are preferably made of a rigid material such as non-deforming plastic. Appendage components could be used with suitable joints and linkages, as well as internal bone-like structure, so that the desired appendage movement is achieved in response to hook movement and tendon tension. The tendon of this invention is preferably imbedded within the appendages, except for the portion in proximity to the longitudinal axis of the lure that contacts the hook bend. As shown in FIG. 4, the tendon may be a wire or other material with little deformation at load levels that would be applied by pulling on a fishing line (typically 2 to 40 pounds). By varying the relative deformation characteristics of the tendon and the material of flexible appendages, different types of realistic appendage movement will result from tendon movement. The selection of these materials would be well known to one skilled in the art. A tendon end may be anchored to the lure (or lure appendage) in a manner known in the art, such as with pins or other solid structures molded into the lure or inserted in the lure and fixed in place.

In another embodiment, there is no tendon but an actuator is incorporated in the lure body such that the actuator is attached to or integral with the appendages. FIG. 3 shows actuator 40 which is molded as part of soft lure body 2 and is continuous with the lure body and appendages 32 and 34. Actuator 40 serves as a connection between the appendages of the fishing lure. The bend of a hook sliding in channel 4 would engage actuator 40 with appendage movement resulting. In this configuration it is preferred that the material of the lure body, appendages, and actuator provide biasing to return those elements to their original position when the force applied on the actuator by the hook is removed. In the embodiment shown in FIG. 3 it is preferred that the actuator be integrally molded with the body of the fishing lure, meaning that in the case of a soft plastic lure the actuator, the appendages, and the lure body are all molded from the same material in a single molding process.

In use, the fisher attaches a fishing line to the eye of the hook placed within the lure and pulls on the line as the lure is retrieved. Increased force on the line results in the hook sliding in the tube, with the bend of the hook engaging the tendon. As the tendon is pulled, the appendages move with direct or mechanical motion. A jerky retrieve of the lure, with fluctuating force on the line and fluctuating movement of the hook, would result is particularly realistic direct movement of the appendage(s). FIG. 4 shows the configuration of the lure when the hook is pulled forward (against the biasing of the appendages and/or tendon).

FIG. 4 also shows spring 42 and hook stop 44. Spring 42 is positioned inside channel 4 or tube 7 and hook stop 44 is rigidly attached to the hook shank. Spring 42 is compressed between hook stop 44 and constricting neck 20 when tension is applied to the eye of the hook. The spring compression is an alternative approach of providing the biasing described in this specification.

In another embodiment of this invention, as shown in FIG. 5, the lure body comprises a rear portion 52 that as attached to the appendages 54, 56 and a forward body portion 50 that is compressible. Rear portion 52 would be less compressible than forward body portion 50. For example, the forward body portion 50 could be hollow soft plastic, while rear portion 52 could be solid soft plastic. In the embodiment, it would be preferable, but not necessary, to utilize a tube 7 as described above with the tube fixed to the rear body portion 50, but slidable within the forward body portion. Force applied to the hook eye compresses the forward body portion as the hook moves forward through the tube 7, with the front of the tube suitably anchored to the front of the forward body portion. As the hook bend 18 moves forward, it engages actuator 40 thereby moving appendages 54 and 56. The biasing that is desired for this invention would be provided by the compression of the forward body portion.

As described about, there are many advantages to the present invention. Most importantly, realistic appendage movement. The structure of the fishing lure is simple, with only the tendon or actuator structure creating any additional manufacturing steps. A further advantage is that if a fish bites the lure of the present invention, the hook is embedded in the mouth of the fish with the other end tied to the fishing line, with no separate elements between the hook and the line. In some prior art lures there are mechanical linkages, lure structure with screwed-on hooks, or other elements between the hook and the line. It is advantageous to provide the direct line to hook eye connection described here.

By modifying the appendage structure, utilizing joints, varying soft and rigid portions, modifying the actuator or tendon attachment and pivot points, a wide variety of appendage movement may be achieved. In particular, the degree of appendage movement for a given amount of hook bend movement can be adjusted as would be known to one skilled in the art. Rigid members within a soft appendage body may be used to serve like a bone-like “skeleton” to further vary the movement of the appendage structure to create more realistic movement.

In another embodiment the hook bend could include an indentation (preferably circular) or integral ring or eye for receiving the tendon to reduce the tendency of the tendon to slide along the arc of the hook bend.

I claim:

1. A fishing lure comprising a body having at least one appendage and a tendon connected to said appendage, said body capable of receiving a hook, whereby said hook engages said tendon such that displacement of said hook causes movement of said appendage.

2. The fishing lure of claim 1, said appendage having a first position and biased to return to said first position after movement away from said first position.

3. The fishing lure of claim 2, further comprising biasing means causing said appendage to return to said first position.

4. The fishing lure of claim 3, said biasing means comprising a spring.

5. The fishing lure of claim 1, further comprising an approximately longitudinal channel in said body.

6. The fishing lure of claim 2, further comprising an approximately longitudinal channel in said body.

7. The fishing lure of claim 5, further comprising a tube disposed in channel, said tube configured for receiving said hook.

8. The fishing lure of claim 6, further comprising a tube disposed in channel, said tube configured for receiving said hook.

9. The fishing lure of claim 1 said hook having a bend, and further comprising an opening in the bottom of said body configured for receiving said hook bend when said hook is displaced.

10. The fishing lure of claim 2 said hook having a bend, and further comprising an opening in the bottom of said body configured for receiving said hook bend when said hook is displaced.

11. The fishing lure of claim 1 said body comprising a more compressible front portion and a less compressible rear portion, such that force applied to said hook results in compression of said front portion and displacement of said hook relative to said rear portion.

12. The fishing lure of claim 2 said body comprising a more compressible front portion and a less compressible rear portion, such that force applied to said hook results in compression of said front portion and displacement of said hook relative to said rear portion.

13. The fishing lure of claim 1 wherein said hook is located at approximately the longitudinal axis of said body and is displaced forward and back along this axis.

14. The fishing lure of claim 2 wherein said hook is located at approximately the longitudinal axis of said body and is displaced forward and back along this axis.

15. The fishing lure of claim 1 wherein said appendage includes at least one rigid bone-simulating component.

16. The fishing lure of claim 2 wherein said appendage includes at least one rigid bone-simulating component.

17. A fishing lure comprising a body having two appendages and said body having an actuator, said body capable of receiving a hook, whereby said hook engages said actuator such that displacement of said hook causes movement of said appendage.

18. The fishing lure of claim 17 said body having a longitudinal channel for receiving said hook.

19. The fishing lure of claim 17 said actuator integrally molded with said body.

20. The fishing lure of claim 18 said actuator positioned between said appendages and perpendicular to said longitudinal channel,
